(19) United States
(12) Patent Application Publication
(10) Pub. No.: US 2002/0198995 A1
(43) Pub. Date: Dec. 26, 2002

(54) Apparatus and methods for maximizing service-level-agreement profits

(75) Inventors: Zhen Liu, Tarrytown, NY (US); Mark S. Squillante, Pound Ridge, NY (US); Joel Leonard Wolf, Katonah, NY (US)

Correspondence Address: Carstens, Yee and Cahoon, L.L.P., P.O. Box 802334, Dallas, TX, 75380, US

(73) Assignee: International Business Machines Corporation, Armonk, NY

(21) Appl. No.: 09/832,438

(22) Filed: Apr. 10, 2001

(51) Int. Cl. G06F 15/173

(52) U.S. Cl. 709/226

(57) ABSTRACT

Apparatus and methods for maximizing service-level-agreement (SLA) profits are provided. The apparatus and methods consist of formulating SLA profit maximization as a network flow model with a separable set of concave cost functions at the servers of a Web server farm. The SLA classes are taken into account with regard to constraints and cost fiction where the delay constraints are specified as the tails of the corresponding response-time distributions. This formulation simultaneously yields both optimal load balancing and server scheduling parameters under two classes of server scheduling policies, Generalized Processor Sharing (GPS) and Preemptive Priority Scheduling (PPS). For the GPS case, a pair of optimization problems are iteratively solved in order to find the optimal parameters that assign traffic to servers and server capacity to classes of requests. For the PPS case, the optimization problems are iteratively solved for each of the priority classes, and an optimal priority hierarchy is obtained.

### TECHNICAL FIELD

The present invention is directed to an improved distributed computer system. More particularly, the present invention is directed to apparatus and methods for maximizing service-level-agreement (SLA) profits.

### DESCRIPTION OF RELATED ART

As the exponential growth in Internet usage continues, much of which is fueled by the growth and requirements of different aspects of electronic business (e-business), there is an increasing need to provide Quality of Service (QoS) performance guarantees across a wide range of high-volume commercial Web site environments. A fundamental characteristic of these commercial environments is the diverse set of services provided to support customer requirements. Each of these services have different levels of importance to both the service providers and their clients. To this end, Service Level Agreements (SLAs) are established between service providers and their clients so that different QoS requirements can be satisfied. This gives rise to the definition of different classes of services. Once a SLA is in effect, the service providers must make appropriate resource management decisions to accommodate these SLA service classes.

One such environment in which SLAs are of increasing importance is in Web server farms. Web server farms are becoming a major means by which Web sites are hosted. The basic architecture of a Web server farm is a cluster of Web servers that allow various Web sites to share the resources of the farm, i.e. processor resources, disk storage, communication bandwidth, and the like. In this way, a Web server farm supplier may host Web sites for a plurality of different clients.

In managing the resources of the Web server farm, traditional resource management mechanisms attempt to optimize conventional performance metrics such as mean response time and throughput. However, merely optimizing performance metrics such as mean response time and throughput does not take into consideration tradeoffs that may be made in view of meeting or not meeting the SLAs being managed. In other words, merely optimizing performance metrics does not provide an indication of the amount of revenue generated or lost due to meeting or not meeting the service level agreements.

Thus, it would be beneficial to have an apparatus and method for managing system resources under service level agreements based on revenue metrics rather than strictly using conventional performance metrics in order to maximize the amount of profit generated under the SLAs.

### SUMMARY OF THE INVENTION

The present invention provides apparatus and methods for maximizing service-level-agreement (SLA) profits. The apparatus and methods consist of formulating SLA profit maximization as a network flow model with a separable set of concave cost functions at the servers of a Web server farm. The SLA classes are taken into account with regard to constraints and cost function where the delay constraints are specified as the tails of the corresponding response-time distributions. This formulation simultaneously yields both optimal load balancing and server scheduling parameters under two classes of server scheduling policies, Generalized Processor Sharing (GPS) and Preemptive Priority Scheduling (PPS). For the GPS case, a pair of optimization problems are iteratively solved in order to find the optimal parameters that assign traffic to servers and server capacity to classes of requests. For the PPS case, the optimization problems are iteratively solved for each of the priority classes, and an optimal priority hierarchy is obtained.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a network data processing system according to one embodiment of the present invention;

FIG. 2 is an exemplary block diagram illustrating a server device according to one embodiment of the present invention;

FIG. 3 is an exemplary block diagram illustrating a client device according to one embodiment of the present invention;

FIG. 4 is an exemplary diagram of a Web server farm in accordance with the present invention;

FIG. 5 is an exemplary diagram illustrating this Web server farm model according to the present invention;

FIGS. 6A and 6B illustrate a queuing network in accordance with the present invention;

FIG. 7 is an exemplary diagram of a network flow model in accordance with the present invention;

FIG. 8 is a flowchart outlining an exemplary operation of the present invention in a GPS scheduling environment; and

FIG. 9 is a flowchart outlining an exemplary operation of the present invention in a PPS scheduling environment.

### DETAILED DESCRIPTION OF THE PREFERRED EMBODIMENT

As mentioned above, the present invention provides a mechanism by which profits generated by satisfying SLAs are maximized. The present invention may be implemented in any distributed computing system, a stand-alone computing system, or any system in which a cost model is utilized to characterize revenue generation based on service level agreements. Because the present invention may be implemented in many different computing environments, a brief discussion of a distributed network, server computing device, client computing device, and the like, will now be provided with regard to FIGS. 1-3 in order to provide an context for the exemplary embodiments to follow. Although a preferred implementation in Web server farms will be described, those skilled in the art will recognize and appreciate that the present invention is significantly more general purpose and is not limited to use with Web server farms.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

In addition to the above, the distributed data processing system 100 may further include a Web server farm 125 which may host one or more Web sites 126-129 for one or more Web site clients, e.g. electronic businesses or the like. For example, the Web server farm 125 may host a Web site for “Uncle Bob's Fishing Hole” through which customers may order fishing equipment, a Web site for “Hot Rocks Jewelry” through which customers may purchase jewelry at wholesale prices, and a Web site for “Wheeled Wonders” where customers may purchase bicycles and bicycle related items.

A user of a client device, such as client device 108 may log onto a Web site hosted by the Web server farm 125 by entering the URL associated with the Web site into a Web browser application on the client device 108. The user of the client device 108 may then navigate the Web site using his/her Web browser application, selecting items for purchase, providing personal information for billing purposes, and the like.

With the present invention, the Web site clients, e.g. the electronic businesses, establish service level agreements with the Web server farm 125 provider regarding various classes of service to be provided by the Web server farm 125. For example, a service level agreement may indicate that a browsing client device is to be provided a first level of service, a client device having an electronic shopping cart with an item therein is provided a second level of service, and a client device that is engaged in a “check out” transaction is given a third level of service. Based on this service level agreement, resources of the Web server farm are allocated to the Web sites of the Web site clients to handle transactions with client devices. The present invention is directed to managing the allocation of these resources under the service level agreements in order to maximize the profits obtained under the service level agreements, as will be described in greater detail hereafter.

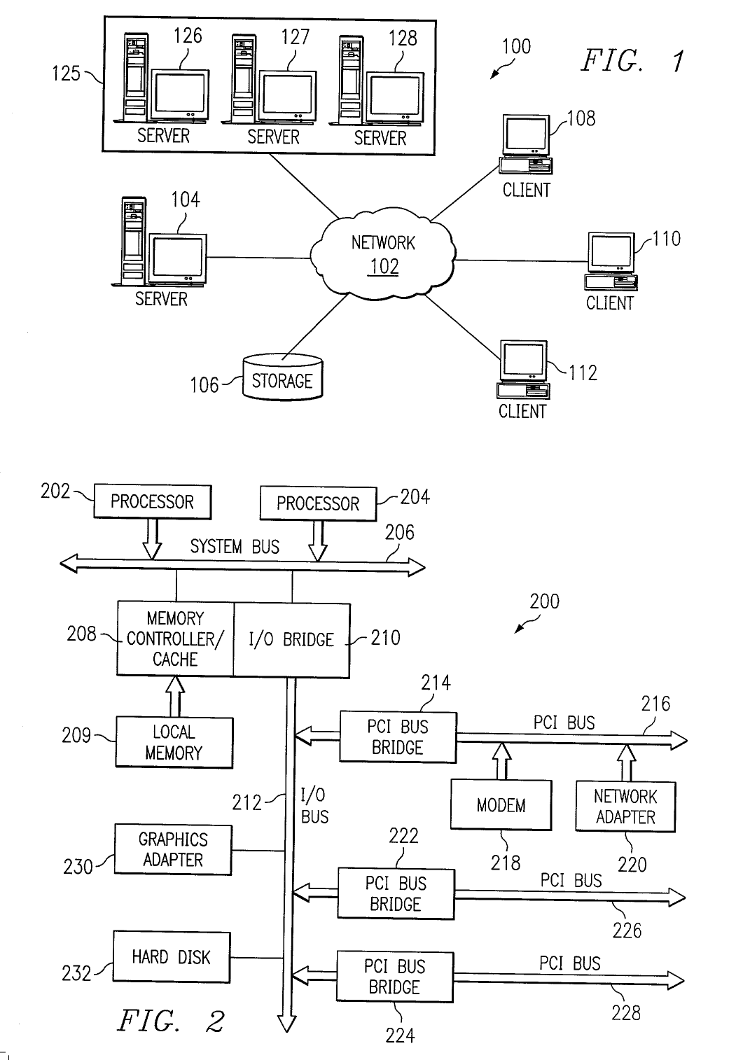

Referring to FIG. 2, a block diagram of a data processing system that may be implemented as a server, such as server 104 or a server in the Web server farm 125 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention. The data processing system depicted in FIG. 2 may be, for example, an IBM RISC/System 6000 system, a product of International Business Machines Corporation in Armonk, N.Y., running the Advanced Interactive Executive (AIX) operating system.

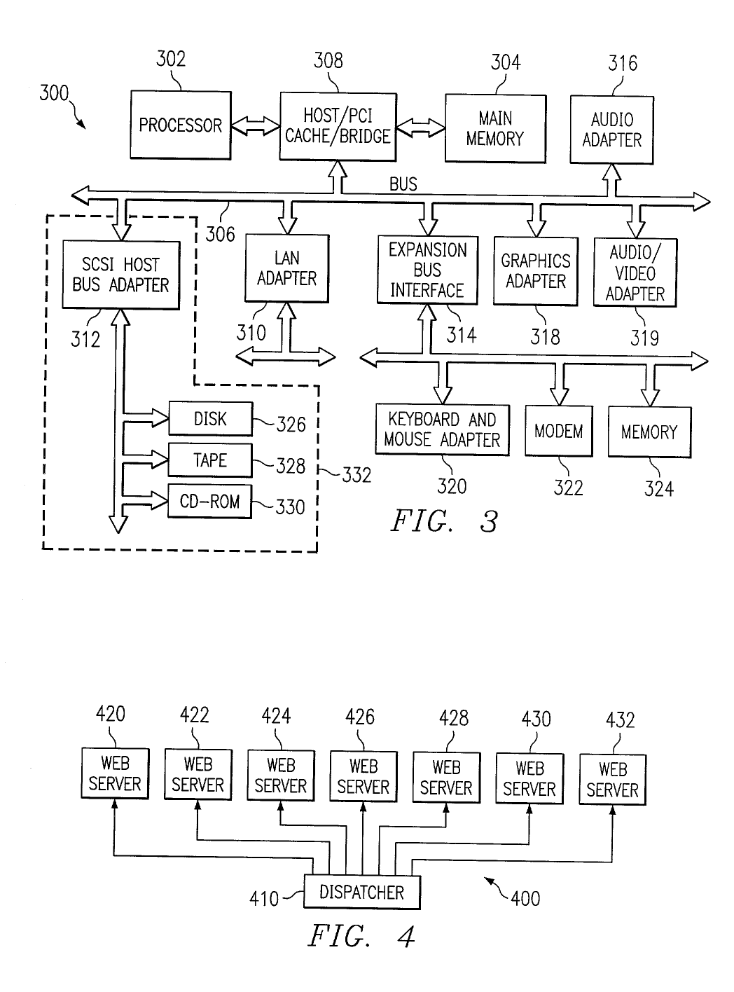

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a mechanism by which resources are managed so as to maximize the profit generated by satisfying service level agreements. The present invention will be described with regard to a Web server farm, however the invention is not limited to such. As mentioned above, the present invention may be implemented in a server, client device, stand-alone computing system, Web server farm, or the like.

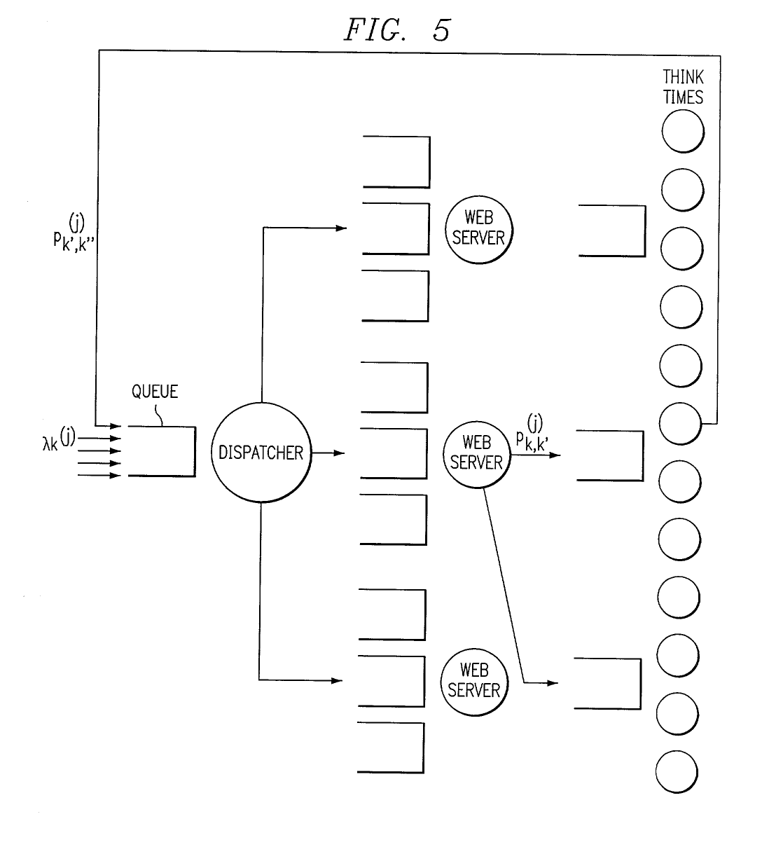

With the preferred embodiment of the present invention, as shown in FIG. 4, a Web server farm 400 is represented by a distributed data processing system consisting of M heterogeneous servers that independently execute K classes of request streams, where each request is destined for one of N different Web client Web sites. As shown in FIG. 4, the Web server farm 400 includes a request dispatcher 410 coupled to plurality of servers 420-432. The request dispatcher 410 receives requests via the network 102 destined for a Web site supported by the Web server farm 400. The request dispatcher 410 receives these requests, determines an appropriate server to handle the request, and reroutes the request to the identified server. The request dispatcher 410 also serves as an interface for outgoing traffic from the Web server farm 400 to the network 102.

Every Web site supported by the Web server farm 400 has one or more classes of requests which may or may not have service level agreement (SLA) requirements. The requests of each class for each Web site may be served by a subset of the servers 420-432 comprising the Web server farm 400. Further, each server 420-432 can serve requests from a subset of the different class-Web site pairs.

To accommodate any and all restrictions that may exist in the possible assignments of class-Web site pairs to servers (e.g., technical, business, etc.), these possible assignments are given via a general mechanism. Specifically, if A(i,j,k) is the indicator function for these assignments, A(i,j,k) takes on the value 0 or 1, where 1 indicates that class k requests destined for Web site j can be served by server i and 0 indicates they cannot. Thus, A(i,j,k) simply defines the set of class-Web site requests that can be served by a given server of the Web server farm.

The present invention provides a mechanism for controlling the routing decisions between each request and each server eligible to serve such request. More precisely, the present invention determines an optimal proportion of traffic of different classes to different Web sites to be routed to each of the servers. Thus, the present invention determines which requests are actually served by which servers in order to maximize profits generated under SLAs.

Web clients use the resources of the Web server farm 400 through their navigation behavior on the hosted Web sites. This navigational behavior is characterized by Web sessions consisting of a sequence of alternating actions. A typical Web client scenario might consist of several browse requests, possibility followed by an add-to-shopping cart request or buy transaction request, in an iterative manner. Between requests, there may be client device-based delays, which can represent user “think times,” fixed time intervals generated by a computer (e.g., Web crawlers or the like), Web browser application delays (e.g., upon requesting embedded let images), and the like. This sequence can be finite or infinite, with the latter case corresponding to Web crawler activities. For a single session, the requests may belong to different classes and as the think times may be of different types.

The present invention is premised on the concept that revenue may be generated each time a request is served in a manner that satisfies the corresponding service level agreement. Likewise, a penalty may be paid each time a request is not served in a manner that satisfies the corresponding service level agreement. The only exception to this premise is “best efforts” requirements in service level agreements which, in the present invention, have a flat rate pricing policy with zero penalty. Thus, the profit generated by hosting a particular Web site on a Web server farm is obtained by subtracting the penalties from the revenue generated. The present invention is directed to maximizing this profit by efficiently managing the Web server farm resources.

### Web Server Farm Model

With the present invention, the Web server farm is modeled by a multiclass queuing network composed of a set of M single-server multiclass queues and a set of NxKxK queues. The former represents a collection of heterogeneous Web servers and the latter represents the client device-based delays (or “think times”) between the service completion of one request and the arrival of a subsequent request within a Web session. FIG. 5 is an exemplary diagram illustrating this Web server farm model. For convenience, the servers of the first set, i.e. the Web servers, are indexed by i, i=1, . . . ,M and those of the second set (delay servers) are indexed by (j, k, k′), the Web client sites by j,j=1, . . . ,N, and the request classes by k, k=1, . . . ,K.

For those M single-server multiclass queues representing the Web servers, it is assumed, for simplicity, that each server can accommodate all classes of requests, however the invention is not limited to such an assumption. Rather, the present invention may be implemented in a Web server farm in which each server may accommodate a different set of classes of requests, for example. The service requirements of class k requests at server i follow an arbitrary distribution with mean l_{i,k}⁻¹. The capacity of server i is denoted by Cᵢ.

The present invention may make use of either a Generalized Processor Sharing (GPS) or Preemptive Priority Scheduling (PPS) scheduling policy to control the allocation of resources across the different service classes on each server. Under GPS, each class of service is assigned a coefficient, referred to as a GPS assignment, such that the server capacity is shared among the classes in proportion to their GPS assignments. Under PPS, scheduling is based on relative priorities, e.g. class 1 requests have a highest priority, class 2 requests have a lower priority than class 1, and so on.

In the case of GPS, the GPS assignment to class k on server i is denoted by f_{i,k} with the sum of f_{i,k} over the range of k=1 to k=K being 1. Thus, at any time t, the server capacity devoted to class k requests, if any, is f_{i,k}C/S _{k′cKi(t)}f_{i,k}, where Kᵢ(t) is the set of classes with backlogged requests on server i at time t. Requests within each class are executed either in a First-Come-First Served (FCFS) manner or in a processor sharing (PS) manner. User transactions from a client device destined for a Web site j that begin with a class k request, arrive to the distributed data processing system, i.e. the Web server farm, from an exogenous source with rate kₖ^{(j)}. Upon completion of a class k request, the corresponding Web site j user transaction either returns as a class k′ request with probability p^{(j)}_{k,k′} following a delay at a queue having mean (d^{(j)}_{k,k′})⁻¹, or completes with probability 1-S^{K}ₗ₌₁p^{(j)}_{k,l}. The matrix P^{(j)}=[p^{(j)}_{k,k′}] is the corresponding request feedback matrix for Web site j which is substochastic and has dimension KxK. This transition probability matrix P^{(j)} defines how each type of Web site j user transaction flows through the queuing network as a sequence of server requests and client think times. Thus, this matrix may be used to accurately reflect the inter-request correlations resulting from client-server interactions. The client device think times can have arbitrary distributions, depending on the Web site and the current and future classes. These think times are used in the model to capture the complete range of causes of delays between the requests of a user session including computer delays (e.g., Web crawlers and Web browsers) and human delays.

Lₖ^{(j)} denotes the rate of aggregate arrivals of Web site j, class k requests to the set of servers of the Web server farm. The rate of aggregate arrivals may be determined based on the exogenous arrival rates and the transition probabilities as follows:

$${L}_{k}^{( j )} = S {{{L}_{k}^{( j )}}^{K}}_{{k}^{′} = 1} {p}_{k , {k}^{′}}^{( j )} + {k}_{k}^{( j )} , j = 1 , … , N , k = 1 , … , K \qquad ( 1 )$$

While the above models uses a Markovian description of user navigational behavior, the present invention is not limited to such. Furthermore, by increasing the number of classes and thus, the dimensions of the transition probability matrix, any arbitrary navigational behavior with particular sequences of request classes may be modeled. In such cases, many of the entries of the transition probability matrix P^{(j)} will be 0 or 1. In so doing, any arbitrary distribution of the number of requests within a session may be approximated.

### Cost Model

As mentioned above, the present invention is directed to maximizing the profit generated by hosting a Web site on a Web server farm. Thus, a cost model is utilized to represent the costs involved in hosting the Web site. In this cost model, k_{i,k}^{(j)} is used to denote the rate of class k requests destined for Web site j that are assigned to server i by the control policy of the present invention. The scheduling discipline, either GPS or PPS, at each single-server multiclass queue determines the execution ordering across the request classes.

The cost model is based on the premise that profit is gained for each request that is processed in accordance with its per-class service level agreement. A penalty is paid for each request that is not processed in accordance with its per-class service level agreement. More precisely, assume Tₖ is a generic random variable for the class k response time process, across all servers and all Web sites. Associated with each request class k is a SLA of the form:

P[Tₖ>zₖ][aₖ (2)

where zₖ is a delay constraint and aₖ is a tail distribution objective. In other words, the class k SLA requires that the response times of requests of class k across all Web sites must be less than or equal to zₖ at least (1-aₖ)*100 percent of the time in order to avoid SLA violation penalties. Thus, the cost model is based on incurring a profit Pₖ⁺ for each class k request having a response time of at most zₖ (i.e. satisfying the tail distribution objective) and incurring a penalty Pₖ⁻ for each class k request which has a response time exceeding zₖ (i.e. fails the tail distribution objective).

One request class is assumed to not have an SLA and is instead served on a best effort basis. The cost model for each best effort class k is based on the assumption that a fixed profit Pₖ⁺ is gained for the entire class, independent of the number of class k requests executed. For simplicity, it will be assumed that there is only one best effort class, namely class K, however it is straightforward to extend the present invention to any number of best effort classes.

### SLA Profit Maximization: GPS Case

Resource management with the goal of maximizing the profit gained in hosting Web sites under SLA constraints will now be considered. As previously mentioned, the foregoing Web server farm model and cost models will be considered under two different local scheduling policies for allocating server capacity among classes of requests assigned to each server. These two policies are GPS and PPS, as previously described. The GPS policy will be described first.

In the GPS policy case, the aim is to find the optimal traffic assignments k_{i, k}^{(j)} and GPS assignments f_{i,k} that maximize the profit, given the class-Web site assignments A(i,j,k) and the exogeneous arrival rates kₖ^{(j)} which yields the aggregate arrival rates Lₖ^{(j)} through equation (1). Here k_{i, k}^{(j)} denotes the rate of class k, Web site j requests assigned to server i and f_{i,k} denotes the GPS assignment for class k at server i.

Routing decisions at the request dispatcher 410 are considered to be random, i.e. a class k request for site j is routed to server i with probability k_{i, k}^{(j)}/S^{M}_{i′=1}k_{i′,k}^{(j)}, independent of the past and future routing decisions. When other routing mechanisms are used, such as weighted round robin, the resource management solutions of the present invention may be used for setting the parameters of these mechanisms (e.g., the weights of the weighted round robin), thus yielding suboptimal solutions.

With the present invention, the queuing network model described above is first decomposed into separate queuing systems. Then, the optimization problem is formulated as the sum of costs of these queuing systems. Finally, the optimization problem is solved. Thus, by summing the profits and penalties of each queuing system and then summing the profits and penalties over all of the queuing systems for a particular class k request to a Web site i, a cost function may be generated for maintaining the Web site on the Web server farm. By maximizing the profit in this cost function, resource management may be controlled in such a way as to maximize the profit of maintaining the Web site under the service level agreement.

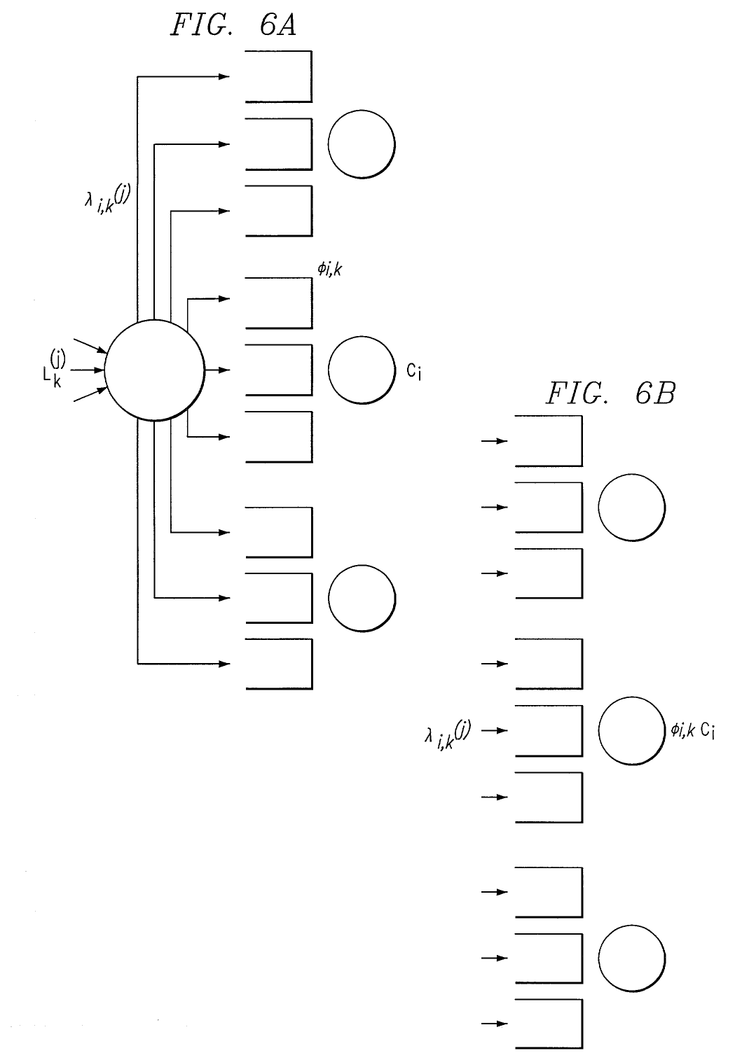

In formulating the optimization problem as a sum of the costs of the individual queuing systems, only servers 1, . . . ,M need be considered and these queuing systems may be considered to have arrivals of rate k_{i, k}hS^{N}ⱼ₌₁k_{i, k}^{(j)} for each of the classes k=1, . . . ,K on each of the servers i=1, . . . ,M. The corresponding queuing network is illustrated in FIGS. 6A and 6B.

These queuing systems are analyzed by deriving tail distributions of sojourn times in these queues in view of the SLA constraints. Bounding techniques are utilized to decompose the multiclass queue associated with server i into multiple single-server queues with capacity f_{i,k}^{C}ᵢ. The resulting performance characteristics (i.e. sojourn times) are upper bounds on those in the original systems.

For simplicity of the analysis and tractability of the optimization, the GPS assignments are assumed to satisfy k_{i, k}<l_{i,k}Cᵢ. It then follows from standard queuing theory that the equation (2) can be bound on the left-hand side by

P[Tₖ>zₖ][exp(−(1_{i,k}f_{i,k}Cᵢ-k_{i,k})zₖ), k=1, . . . ,K−1 (3)

Hence, the SLA constraint is satisfied when

P[Tₖ>zₖ][exp(−(1_{i,k}f_{i,k}Cᵢ-k_{i, k})zₖ)[aₖ, k=1, . . . ,K−1 (4)

Next, the optimization problem is divided into separate formulations for the SLA-based classes and the best effort class. As a result of equation (4), the formulation of the SLA classes is given by:

$$Max {{S}_{i = 1}}^{M} {{S}_{k = 1}}^{K - 1} {P}_{k}^{+} {k}_{i , k} - ( {P}_{k}^{+} + {P}_{k}^{-} ) {k}_{i , k} exp ( - ( {l}_{i , k} {f}_{i , k} {C}_{i} - {k}_{i , k} ) {z}_{k} ) \\ \begin{matrix}s . t . {k}_{i , k} [ ln ( {a}_{k} {z}_{k} ) / {z}_{k} + {l}_{i , k} {f}_{i , k} {C}_{i} , i = 1 , … , M , k = 1 , … , K - 1 ; \\ {{S}_{J = 1}}^{N} {k}_{i , k}^{( j )} = {k}_{i , k} , i = 1 , … , M , k = 1 , … , K - 1 ; \\ {{S}_{i = 1}}^{M} {k}_{i , k}^{( j )} = {L}_{k}^{( j )} , j = 1 , … , N , k = 1 , … , K - 1 ; \\ {k}_{i , k}^{( j )} = 0 , if A ( i , j , k ) = 0 , k = 1 , … , K - 1 ; \frac{1}{4 i , j} \\ {k}_{i , k}^{( j )} m 0 , if A ( i , j , k ) = 1 , k = 1 , … , K - 1 ; \frac{1}{4 i , j} \\ {{S}_{k = 1}}^{K - 1} = {f}_{i , k} [ 1 , i = 1 , … , M .\end{matrix} \qquad ( 5 )$$

where zₖ is a scaling factor for the SLA constraint aₖ, and Ci is the capacity of server i. Here, the k_{i, k}^{(j)} and f_{i,k} are the decision variables sought and Pₖ⁺, Pₖ⁻, Cᵢ,kₖ^{(j)}, zₖ,aₖ,zₖ,and 1_{i,k} are input are input parameters. By allowing zₖ to go to infinity for any class k, the cost model makes it possible to include the objective of maximizing the throughput for class k.

The formulation for the optimal control problem for the best efforts classes attempts to minimize the weighted sum of the expected response time for class K requests over all servers, and yields:

$$Min {{S}_{i = 1}}^{M} {n}_{i , K} ( ( {S}_{k = 1}^{K} {k}_{i , k} {b}_{i , k}^{( 2 )} ) / ( 2 ( 1 - {q}_{i , K - 1}^{+} ) ( 1 - {q}_{i , K}^{+} ) ) + {b}_{i , K} / ( 1 - {q}_{i , K - 1}^{+} ) ) \\ \begin{matrix}s . t . {k}_{i , k} [ {\overline{l}}_{i , K} {C}_{i} , i = 1 , … , M ; \\ {\overline{C}}_{i} = Ci - {{S}_{k = 1}}^{K - 1} {k}_{i , k} / {l}_{i , k} , i = 1 , … , M ; \\ {{S}_{i = 1}}^{M} {k}_{i , K}^{( j )} = {L}_{K}^{( j )} , j = 1 , … , N ; \\ {k}_{i , K}^{( j )} = 0 , if A ( i , j , K ) = 0 , i = 1 , … , M , j = 1 , … , N ; \\ {k}_{i , K}^{( j )} m 0 , if A ( i , j , K ) = 1 , i = 1 , … , M , j = 1 , … , N .\end{matrix} \qquad ( 6 )$$

where n_{i,K} is the weighting factor for the expected response time of the best effort class K on server i, b_{i,k}, b_{i,k}⁽²⁾ are the first two moments of the service times (b_{i,k}=1_{i,k}/Cᵢ), and q_{i,k}⁺ is the total load of classes 1, . . . ,k:

$${q}_{i , k}^{+} = {{S}_{{k}^{′} = 1}}^{k} {q}_{i , {k}^{′}} h {{S}_{{k}^{′} = 1}}^{k} {k}_{i , {k}^{′}} {b}_{i , {k}^{′}} / {C}_{i} \qquad ( 7 )$$

Here, k_{i k}^{(j)} are the decision variable that are sought and the remaining variables are input parameters.

The expression of the response time in the above cost function comes from the queuing results on preemptive M/G/1 queues, which are describe in, for example, H. Takasi, Queuing Analysis, vol. 1, North-Holland, Amsterdam, 1991, pages 343-347, which is hereby incorporated by reference. The use of these queuing results is valid since the SLA classes are assigned the total capacity. The GPS assignment for best effort class requests is 0, which results in a priority scheme between SLA classes and the best effort class. Furthermore, owing to the product-form solution, a Poisson model may be used for higher priority class requests.

The weights n_{i,K} are included in the formulation as they may be greater use when there are multiple best efforts classes, e.g., classes K through K′. As a simple example, the weights n_{i,K} may be set to Pₖ⁺/(P_{K}⁺+. . .+P_{K+K′}⁺) in this case.

In the above formulation of equation (5), the scaling factors zₖ>1 are used to generalize the optimization problem. Several practical considerations motivate the use of such scaling factors. Observe first that the use of most optimization algorithms requires that the cost functions be explicit and exhibit certain properties, e.g., differentiability and convexity/concavity. However, for scheduling policies like GPS, the resulting queuing model is usually very difficult to analyze and bounding or approximation techniques have to be used in order to obtain tail distributions. Such an approach results in a bound for the GPS scheduling policy. Thus, the use of the scaling factors allows this bias to be corrected.

Secondly, queuing models are only mathematical abstractions of the real system. Users of such queuing models usually have to be pessimistic in the setting of model parameters. Once again, the scaling factors zₖ>1 may be useful to bridge the gap between the queuing theoretic analysis and the real system. Furthermore, the scaling factors zₖ>1 make it possible for the hosting company to violate the SLA to a controlled degree in an attempt to increase profits under equation (5), whereas the hosting company will strictly follow the predefined SLA whenever zₖ=1.

There are two sets of decision variables in the formulation of the optimal control problem shown in equation (5), namely, k_{i,k}^{(j)} and f_{i,k}, where the latter variables control the local GPS policy at each server. To address this problem, two subproblems are considered in an iterative manner using the same formulation with appropriately modified constraints to solve for the decision variables k_{i, k}^{(j)} and f_{i,k}. Specifically, the following equations are iteratively solved to solve for the decision variables:

$$\begin{matrix}Max {{S}_{i = 1}}^{M} {{S}_{k = 1}}^{K - 1} {P}_{k}^{+} {k}_{i , k} - ( {P}_{k}^{+} + {P}_{k}^{-} ) {k}_{i , k} exp ( - ( {l}_{i , k} {f}_{i , k} {C}_{i} - {k}_{i , k} ) {z}_{k} ) \\ \begin{matrix}s . t . {k}_{i , k} [ ln ( {a}_{k} {z}_{k} ) / {z}_{k} + {l}_{i , k} {f}_{i , k} {C}_{i} , i = 1 , … , M , k = 1 , … , K - 1 ; \\ {{S}_{j = 1}}^{N} {k}_{i , k}^{( j )} = {k}_{i , k} , i = 1 , … , M , k = 1 , … , K - 1 ; \\ {{S}_{i = 1}}^{M} {k}_{i , k}^{( j )} = {L}_{k}^{( j )} , j = 1 , … , N , k = 1 , … , K - 1 ; \\ {k}_{i , k}^{( j )} = 0 , if A ( i , j , k ) = 0 , k = 1 , … , K - 1 ; \frac{1}{4 i , j} ; \\ {k}_{i , k}^{( j )} m 0 , if A ( i , j , k ) = 1 , k = 1 , … , K - 1 ; \frac{1}{4 i , j} .\end{matrix} & ( 8 ) \\ Max {{S}_{i = 1}}^{M} {{S}_{k = 1}}^{K - 1} {P}_{k}^{+} {k}_{i , {k}^{-}} ( {P}_{k}^{+} + {P}_{k}^{-} ) {k}_{i , k} exp ( - ( {l}_{i , k} {f}_{i , k} {C}_{i} - {k}_{i , k} ) {z}_{k} ) \\ s . t . {f}_{i , k} m {k}_{i , k} / {l}_{i , k} {C}_{i} - ln ( {a}_{k} {z}_{k} ) / {z}_{k} {l}_{i , k} {C}_{i} , i = 1 , … , M , \\ k = 1 , … , K - 1 ; & ( 9 )\end{matrix}$$

Equation (8) is an example of a network flow resource allocation problem. Both equations (8) and (9) can be solved by decomposing the problem into M separable, concave resource allocation problems, one for each class in equation (8) and one for each server in equation (9). The optimization problem (8) has additional constraints corresponding to the site to server assignments. The two optimization problems shown in equations (8) and (9) then form the basis for a fixed-point iteration. In particular, initial values are chosen for the variables f_{i,k} and equation (8) is solved using the algorithms described hereafter to obtain the optimal control variables k_{i, k}^{(j)*}. This set of optimal control variables k_{i, k}^{(j)*} are then substituted into equation (9) and the optimal control variables f_{i,k}^{*} are obtained. This iterative procedure continues until a difference between the sets of control variables of an iteration and those of the previous iteration is below a predetermined threshold. The optimization problems are defined more precisely as follows.

### Optimization Algorithms

There are, in fact, two related resource allocation problems, one a generalization of the other. Solutions to both of these problems are required to complete the analysis. Furthermore, the solution to the special problem is employed in the solution of the general problem, and thus, both will be described.

The more general problem pertains to a directed network with a single source node and multiple sink nodes. There is a function associated with each sink node. This function is required to be increasing, differentiable, and concave in the net flow into the sink, and the overall objective function is the (separable) sum of these concave functions. The goal is to maximize this objective function. There can be both upper and lower bound constraints on the flows on each directed arc. In the continuous case, the decision variables are real numbers. However, for the discrete case, other versions of this algorithm may be utilized. The problem thus formulated is a network flow resource allocation problem that can be solved quickly due to the resulting constraints being submodular.

Consider a directed network consisting of nodes V and directed arcs A. The arcs aᵥ₁ᵥ₂ c A carry flow fᵥ₁ᵥ₂ from nodes v₁ c V to nodes v₂ c V. The flow is a real variable which is constrained to be bounded below by a constant iᵥ₁ᵥ₂ and above by a constant uᵥₗᵥ₂. That is,

iᵥ₁ᵥ₂[fᵥ₁ᵥ₂[uᵥ₁ᵥ₂ (10)

for each arc aᵥ₁ᵥ₂. It is possible, of course, that iᵥ₁ᵥ₂=0 and uᵥ₁ᵥ₂=⁰. There will be a single source node s c V satisfying Saᵥ₂fₛᵥ₂−Saᵥ₁fᵥ₁ₛ=R>0. This value R, the net outflow from the source, is a constant that represents the amount of resource available to be allocated. There are N sinks v₂ c N′ A which have the property that their net inflow Saᵥ₁ᵥ₂fᵥ₁ᵥ₂−Saᵥ₂ᵥ₃fᵥ₂ᵥ₃>0. All other nodes v₂ c A-{s}-N are transhipment nodes that satisfy Saᵥ₁ᵥ₂fᵥ₁ᵥ₂−Saᵥ₂ᵥ₃fᵥ₂ᵥ₃=0. There is increasing, concave, differentiable function Fv₂ for the net flow into each sink node j. So the overall objective function is

$${S {F}_{v2}}_{V2cN} ( S {{f}_{v1v2}}_{av1v2} - {{Sf}_{v2v3}}_{ av2v3} ) \qquad ( 11 )$$

which is sought to be maximized subject to the lower and upper bound constraints described in equation (10).

A special case of this problem is to maximize the sum

$${{S}_{V2 = 1}}^{N} ( {F}_{v2} ( {x}_{v2} ) ) \qquad ( 12 )$$

of a separable set of N increasing, concave, differentiable functions subject to bound constraints

lᵥ₂[xᵥ₂[uᵥ₂ (13)

and subject to the resource constraint

$${{S}_{V2 = 1}}^{N} {x}_{v2} = R \qquad ( 14 )$$

for real decision variables xᵥ₂. In this so-called separable concave resource allocation problem, the optimal solution occurs at the place where the derivatives Fᵥ₂′(xᵥ₂) are equal and equation (14) holds, modulo the bound constraints in equation (13).

More precisely, the algorithm proceeds as follows: If either S^{N}ᵥ₂₌₁lᵥ₂>R or S^{N}ᵥ₂₌₁uᵥ₂>R , there is no feasible solution and the algorithm terminates. Otherwise, the algorithm consists of an outer bisection loop that determines the value of the derivative D and a set of N inner bisection loops that find the value of lᵥ₂ [ xᵥ₂ ] uᵥ₂ satisfying Fᵥ₂′(xᵥ₂)=D if Fᵥ₂′(lᵥ₂) [ D and Fᵥ₂′(uᵥ₂) m D. Otherwise Xᵥ₂ is set to lᵥ₂ (in the first case), or xᵥ₂ is set to uᵥ₂ (in the second case) The initial values for the outer loop can be taken as the minimum of all values Fᵥ₂′(lᵥ₂) and the maximum of all values Fᵥ₂′(uᵥ₂). The initial values for the u₂-th inner loop can be taken to be l^{v2} and uᵥ₂.

The more general problem is itself a special case of the so-called submodular constraint resource allocation problem. It is solved by recursive calls to a subroutine that solves the problem with a slightly revised network and with generalized bound constraints

lᵥ₁ᵥ₂′[fᵥ₁ᵥ₂[uᵥ₁ᵥ₂′ (15)

instead of those in equation (10). As the algorithm proceeds it makes calls to the separable concave resource allocation problem solver. More precisely, the separable concave resource allocation problem obtained by ignoring all but the source and sink nodes is solved first. Let xV2 denote the solution to that optimization problem.

In the next step, a supersink t is added to the original network, with directed arcs jt from each original sink, forming a revised network (V′,A′). Lⱼₜ′ is set to 0 and uⱼₜ′ is set to xᵥ₂ for all arcs connecting the original sinks to the supersink. For all other arcs, the lower and upper bounds remain the same. Thus, lᵥ₁ᵥ₂′=lᵥ₁ᵥ₂ and uᵥ₁ᵥ₂′=ᵥ₁ᵥ₂ for all arcs aᵥ₁ᵥ₂. The so-called maximum flow problem is then solved to find the largest possible flow fᵥ₁ᵥ₂ through the network (V′,A′) subject to constraints in equation (10). A simple routine for the maximum flow problem is the labeling algorithm combined with a path augmentation routine. Using the residual network one can simultaneously obtain the minimum cut partition. For definitions of these terms, please see Ahvja, Magnant, & Orlin, Network Flows, Prentice Hall, Englewood Cliffs, N.J. 1993, pages 44-46, 70, 163 and 185, which is hereby incorporated by reference. Those original sink nodes j which appear in the same partition as the supersink are now regarded as saturated. The flow fᵥ₂ₜ becomes the lower and upper bounds on that arc. Thus, l^{v2t}′ is set to u′ᵥ₂ₜ which is equal to fᵥ₂ₜ. For all remaining unsaturated arcs j, l^{v2t}′ is set to xᵥ₂ and uᵥ₂ₜ′ is set equal to fᵥ₂ₜ. Now the process is repeated, solving the separable concave resource allocation problem for the unsaturated nodes only, with suitably revised total resource, and then solving the revised network flow problem. This process continues until all nodes are saturated, or an infeasable solution is reached.

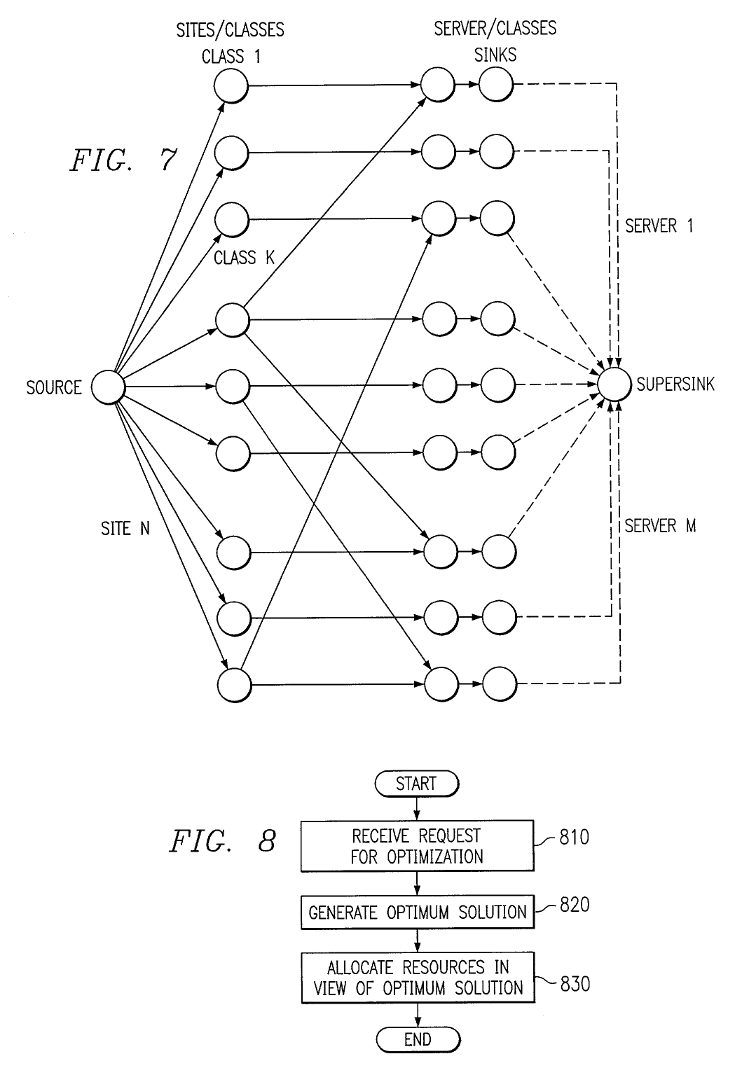

An example of the network flow model is provided in FIG. 7. In addition to the source node s, there are NK nodes corresponding to the sites and classes, followed by two pairs of MK nodes corresponding to the servers and classes, and a supersink t. In the example, M=N=K=3. In the first group of arcs, the (j,k)th node has capacity equal to Lₖ^{(j)}. The second group of arcs corresponds to the assignment matrix A(i,j,k), and these arcs have infinite capacity. The capacities of the third group of arcs on (i,k) correspond to the SLA constraints. The duplication of the nodes here handles the fact that the constraint is really on the server and class nodes. The final group of arcs connects these nodes to the supersink t.

### SLA Profit Maximization: PPS Case

In formulating the SLA based optimization problem under the PPS discipline for allocating server capacity among the classes of requests assigned to each server, the approach is again to decompose the model to isolate the per-class queues at each server. However, in the PPS case, the decomposition of the per-class performance characteristics for each server i is performed in a hierarchical manner such that the analysis of the decomposed model for each class k in isolation is based on the solution for the decomposed models of classes 1 . . . ,k-1.

Assuming that the lower priority classes do not interfere with the processing of class 1 requests, as is the case under PPS, then the product-form results derived above indicate that the arrival process to the class 1 queue is a Poisson process. Hence, equation (5) still holds for class 1 requests which then leads to the following formulation for the class 1 optimal control problem:

$$Max {{S}_{i = 1}}^{M} {P}_{k}^{+} {k}_{i , l} - ( {P}_{l}^{+} + {P}_{l}^{-} ) {k}_{i , l} exp ( - ( {l}_{i , l} {C}_{i} - {k}_{i , l} ) {z}_{l} ) \\ \begin{matrix}s . t . {k}_{i , l} [ ln ( {a}_{l} {z}_{l} ) / {z}_{l} + {l}_{i , l} {f}_{i , l} {C}_{i} , i = 1 , … , M ; \\ {{S}_{J = 1}}^{N} {k}_{i , l}^{( j )} = {k}_{i , l} , i = 1 , … , M ; \\ {{S}_{i = 1}}^{M} {k}_{i , l}^{( j )} = {L}_{l}^{( j )} , j = 1 , … , N ; \\ {k}_{i , l}^{( j )} = 0 , if A ( i , j , l ) = 0 , i = 1 , … , M , j = 1 , … , N ; \\ {k}_{i , l}^{( j )} m 0 , if A ( i , j , l ) = 1 , i = 1 , … , M , j = 1 , … , N ;\end{matrix} \qquad ( 16 )$$

where k_{i,l}^{(j)} are the decision variables and all other variables are as defined above.

Upon solving equation (16) to obtain the optimal control variables k_{i,l}^{(j)*}, it is sought to statistically characterize the tail distribution for the class 2 queue which will then be used (recursively) to formulate and solve the optimization problem for the next class(es) under the PPS ordering. Thus, for any class k equal to 2 or more, it is assumed that there are constants C_{i,k} and h_{i,k} such that

P[T_{i,k}>x]j c_{i,k}e^{-hi,kx} i=1, . . . ,M,k=1, . . . ,K (17)

Assuming that the optimization problem for classes 1, . . . ,k-1 have been solved, the control problem for class k can be formulated as:

$$Max {{S}_{i = 1}}^{M} {P}_{k}^{+} {k}_{i , k} - ( {P}_{k}^{+} + {P}_{k}^{-} ) {k}_{i , k} {c}_{i , k} exp ( - {h}_{i , k} {z}_{k} ) \\ {k}_{i , k} [ ln ( {a}_{k} {z}_{k} ) / {z}_{k} + ( {C}_{i} - {Sp}_{i , {k}^{′}} ) {l}_{i , k} , {{i}_{{k}^{′} = 1}}^{k - 1} = 1 , … , M ; \\ \begin{matrix} {{S}_{j = 1}}^{N} {k}_{i , k}^{( j )} = {k}_{i , k} , i = 1 , … , M ; \\ {{S}_{i = 1}}^{M} {k}_{i , k}^{( j )} = {L}_{k}^{( j )} , j = 1 , … , N ; \\ {k}_{i , k}^{( j )} = 0 , if A ( i , j , k ) = 0 , i = 1 , … , M , j = 1 , … , N ; \\ {k}_{i , k}^{( j )} m 0 , if A ( i , j , k ) = 1 , i = 1 , … , M , j = 1 , … , N ;\end{matrix} \qquad ( 18 )$$

where k_{i, k}^{(j)} are the decision variables and all other variables are as defined above.

In order to apply the optimization algorithms described above, appropriate parameters for C_{i,k} and h_{i,k} must be selected. In one embodiment, the parameters for C_{i,k} and h_{i,k} are selected based on fitting the parameters with the first two moments of the response time distribution, however, other methods of selecting parameters for C_{i,k} and h_{i,k} may be used without departing from the spirit and scope of the present invention.

It follows from equation (17) that for i=1, . . . ,M, k=1, . . . ,K:

ET_{i,k}=c_{i,k}/h_{i,k}, ET_{i,k}²=2c_{i,k}/h_{i,k}² (19)

so that

h_{i,k}=2ET_{i,k}/ET_{i,k}, c_{i,k}=2ET_{i,k}²/ET_{i,k} (20)

where ET_{i,k} and ET_{i,k}² are the first and second moments of T_{i,k}, respectively. Using known formulae for ET_{i,k} and ET_{i,k}², the equations become:

ET_{i,k}=(S^{k}_{k′=1}k_{i, k′}b_{i,k′}⁽²⁾/2(1−q_{i,k-1}⁺) (1−q_{i,k}⁺))+b_{i,k}/(1−q_{i,k-1}⁺) (21)

and

ET_{i,k}²=(S^{k}_{k′=1}k_{i,k′}⁽³⁾/3(1−q_{i,k-1}⁺)²(1−q_{i,k}⁺))+b_{i,k}⁽²⁾/(1−q_{i,k-1}⁺)²+((S^{k}_{k′=1}k_{i, k′}b_{i,k′}⁽²⁾/(1−q_{i,k-1}⁺)(1−q_{i,k}⁺)) +S^{k-1}_{k′=1}k_{i,k′}b_{i,k′}⁽²⁾/(1−q_{i,k-1}⁺)²)ET_{i,k} (22)

where b_{i,k′}, b_{i,k′}⁽²⁾b_{i,k′}⁽³⁾ are the first three moments of the service times, q_{i,k}⁺ is the total load of classes 1, . . . ,k:

q_{i,k}⁺=S^{k}_{k′=1}q_{i,k′}h S^{k}_{k′=1}k_{i, k′}b_{i,k′}/Cᵢ (23)

When the service requirements can be expressed as mixtures of exponential distributions, the cost functions of equation (18) are concave. Therefore, the network flow model algorithms can be recursively applied to classes 1,2, . . . ,K.

### SLA Profit Maximization: General Workload Model

The optimization approach described above can be used to handle the case of even more general workload models in which the exponential exogenous arrival and service process assumptions described above are relaxed. As in the previous cases, analytical expressions for the tail distributions of the response times are derived. In the general workload model, the theory of large deviations is used to compute the desired functions and their upper bounds.

Consider a queuing network composed of independent parallel queues, as shown in FIGS. 6A and 6B. The workload model is set to stochastic processes Uₖ^{(j)}(t) representing the amount of class k work destined for site j that has arrived during the time interval (0,t). The workload model defined in this manner corresponds to Web traffic streams at the request level rather than at the session level, which was the case described above with regard to FIGS. 6A and 6B.

Let b_{i,k} be the decision variables representing the proportion of traffic of Uₖ^{(j)} to be sent to server i: U_{i,k}^{(j)}(t)=b_{i,k}A(i,j,k)Uₖ^{(j)}. Let V_{i,k}(t) be the potential traffic of class k set to server i during the time interval (0,t):

V_{i,k}(t)=Sⁿⱼ₌₁A(i,j,k)Uₖ^{(j)} (25)

and define

$${q}_{i , k} = {lim}_{t t °} ( 1 / t ) {V}_{i , k} ( t ) \qquad ( 26 )$$

to be associated asymptotic potential load of class k at server i, provided the limit exists. Further let

U_{i,k}(t)=S^{N}ⱼ₌₁U_{i,k}^{(J)}(t)=S^{N}ⱼ₌₁b_{i,k}A(i,j,k)Uₖ^{(j)}b_{i,k}V_{i,k} (27)

denote the class k traffic that has been sent to server i during the time interval (0,t). Thus,

$${lim}_{t t °} ( 1 / t ) {U}_{i , k} ( t ) = {b}_{i , k} {q}_{i , k} \qquad ( 28 )$$

Assume again that GPS is in place for all servers with the capacity sharing represented by the decision variables f_{i,k}. The SLA under consideration is

P[Wₖ>zₖ][aₖ, k=1, . . . ,K-1 (29)

where Wₖ is the remaining work of class k at any server.

Bounds of the tail distributions of the remaining class k work at server i are considered by analyzing each of the queues in isolation with service capacity f_{i,k}^{C}ᵢ (see FIG. 6B). Such bounds exist for both arbitrary and Markovian cases. For tractability of the problem, it is assumed that b_{i,k}q_{i,k}<f_{i,k}Cᵢ.

Only asymptotic tail distributions given by the theory of large deviations are considered:

P[W_{i,k}>zₖ]i exp(−h_{i,k}zₖ) (30)

where W_{i,k} is the remaining work of class k at server I. In order to apply the large deviations principal, it is assumed that for all i=1, . . . ,M and k=1 , . . . ,K, the following assumptions hold:

(A1) the arrival process V_{i,k}(t) is stationary and ergodic (see S. Karlin et al., A First Course in Stochastic Processes, 2nd Ed., Academic Press, San Diego, Calif., 1975, pages 443 and 487-488, which is hereby incorporated by reference); and

$$( A 2 ) for all {0 < h < ° , the}_{t t °} limit {L}_{i , k} ( h ) = lim ( 1 / t ) {log}_{e} exp ( h {V}_{i k} ( t ) )$$

exists, and L_{i,k}(h) is strictly convex and differentiable.

Note that for some arrival processes, assumption (A2) is valid only through a change of scaling factor. In this case, the asymptotic expression of the tail distribution of the form in equation (30) could still hold, but with a subexponential distribution instead of an exponential one.

It then follows that under assumptions A1 and A2, the arrival processes Vi,k(t) satisfy the large deviations principal with the rate function

L_{i,k}(a)^{*}=sup(ha−L_{i,k}(h)) (31)

where L_{i,k}(a)^{*} is the Legendre transform of L_{i,k}(h).

Now let

$$\begin{matrix}{L}_{i , k} ( h , {b}_{i k} ) = {lim}_{t t °} ( 1 / t ) log E {e}^{h U i , k ( t )} \\ = {lim}_{t t °} ( 1 / t ) log E {e}^{h b i , k V i , k ( t )}\end{matrix}$$

Then, L_{i,k}(h,b_{i,k})=L_{i,k}(hb_{i,k}), and thus, the exponential decay rate h_{i,k}^{*} is defined by

h_{i,k}^{*}=sup{h c∵L_{i,k}(hb_{i,k})/h<f_{i,k}Cᵢ} (32)

This exponential decay rate is a function of C_{i,k} h f_{i,k}Cᵢ and b_{i,k}, which will be denoted by h_{i,k}^{*}(b_{i,k},C_{i,k}). As h_{i,k}^{*}(b_{i,k},C_{i,k}) decreases and is differentiable in b, x_{i,k}(C,h) can be defined as the inverse of h_{i,k}^{*}(b_{i,k},C_{i,k}) with respect to b, i.e. x_{i,k}(C,h_{i,k}^{*}(b_{i,k},C_{i,k}))=b. The corresponding optimization problem may then be formulated as:

$$\begin{matrix}Max {S}_{i = 1}^{M} {S}_{k = 1}^{K - 1} {P}_{k}^{+} {b}_{i , k} {p}_{i , k} - ( {P}_{k}^{+} + {P}_{k}^{-} ) {b}_{i , k} exp ( - {h}_{i , k} {z}_{k} ) & ( 33 ) \\ \begin{matrix}s . t . {b}_{i , k} [ {{x}_{i , k} ( {f}_{i , k} {C}_{i ,} - log}_{k = 1 , … , K - 1 ;} ( {a}_{k} {z}_{k} ) / {z}_{k} ) , i = 1 , … , M , \\ {b}_{i , k} < {f}_{i , k} {C}_{i} / {p}_{i , k} , i = 1 , … , M , k = 1 , … , K - 1 ; \\ {S}_{i = 1}^{M} {b}_{i , k} = 1 , k = 1 , … , K - 1 ; \\ {S}_{k = 1}^{K - 1} {f}_{i , k} [ 1 , i = 1 , … , M .\end{matrix} & ( 34 )\end{matrix}$$

Note that the constraint in equation (34) comes from the relaxed SLA requirement h_{i,k}^{*}m-log(aₖzₖ)/zₖ.

Owing to the above, the function bexp(−zh_{i,k}^{*}(b,C)) is convex in b, so that the cost function is also concave in the decision variables b_{i, k}. Thus, the optimization alogrithms described above may be iteratively used to solve the control problem.

In the case of Markovian traffic models, such as Markov Additive Processes and Markovian Arrival Processes (see D. Lucantun et al., “A single Server Queue with Server Vacations and a Class of Non-renewal Arrival”, Advances in Applied Probability, vol. 22, 1990, pages 676-705, which is hereby incorporated by reference), such functions can be expressed as the Perron-Ferobenius eigenvalue. Thus, efficient numerical and symbolic computational schemes are available.

FIG. 8 is a flowchart outlining an exemplary operation of the present invention when optimizing resource allocation of a Web server farm. As shown in FIG. 8, the operation starts with a request for optimizing resource allocation being received (step 810). In response to receiving the request for optimization, parameters regarding the Web server farm are provided to the models described above and an optimum solution is generated using these models (step 820). Thereafter, the allocation of resources is modified to reflect the optimum solution generated (step 830). This may include performing incremental changes in resource allocation in an iterative manner until measure resource allocation metrics meet the optimum solution or are within a tolerance of the optimum solution.

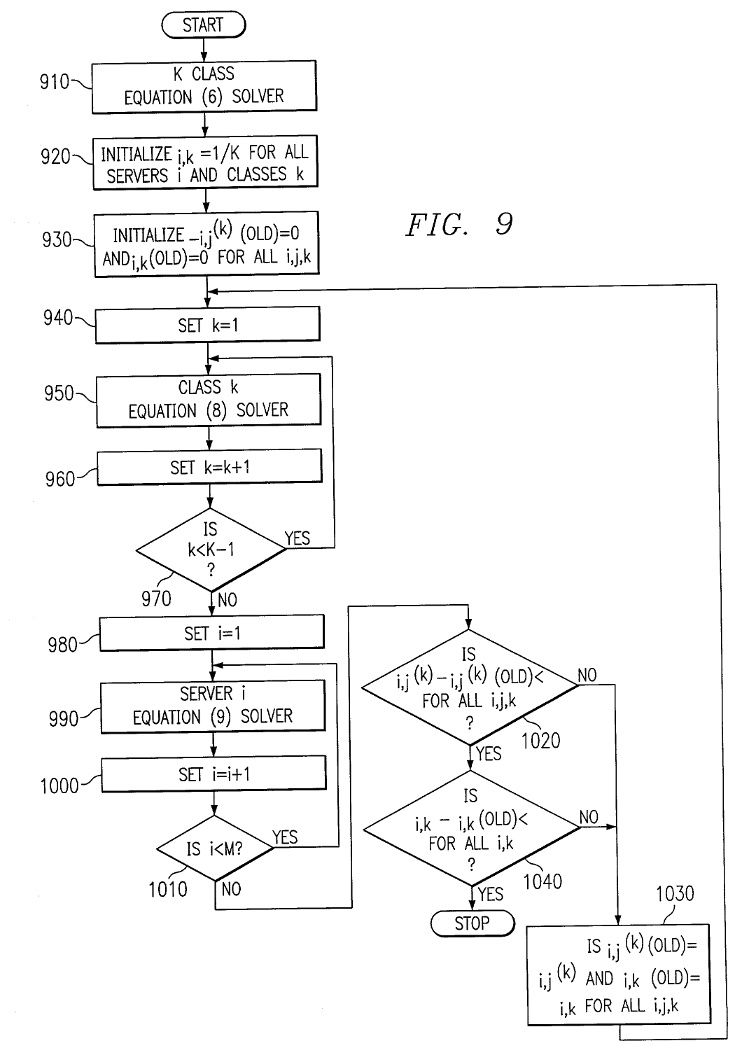

FIG. 9 provides a flowchart outlining an exemplary operation of a resource allocation optimizer in accordance with the present invention. The particular resource allocation optimizer shown in FIG. 9 is for the GPS case. A similar operation for a PPS resource allocation optimizer may be utilized with the present invention as discussed above.

As shown in FIG. 9, the problem of finding the optimal arrival rates k_{i,j}^{(k)} for the two best effort class are solved (step 910). This is outlined in equation (6) above. Next, the GPS parameters f_{i,k} for each server i and class k<K are initialized (step 920). The value of initial parameters may be arbitrarily selected or may be based on empirical data indicating values providing rapid convergence to an optimal solution.

The “previous” arrival rate and GPS parameters k_{i,j}^{(k)} (old) and f_{i,k} (old) are initialized (step 930). The choice of initialization values forces the first test to determine convergence of k_{i,j}^{(k)} and f_{i,k} to fail. The class is initialized to K=1 (step 940) and the problem outlined in equation (8) is solved to obtain the optimal values of the arrival rates k_{i,j}^{(k)} given the values of the GPS parameters f_{i,j} (step 950).

The class k is then incremented (step 960) and it is determined whether k<K-1 (step 970). If it is, the operation returns to step 950. Otherwise, the server is initialized to i=1 (step 980). The problem outlined in equation (9) is solved to obtain the optimal values of the GPS parameters f_{i,j} given the values of the arrival rates k_{i,j}^{(k)} (step 990).

The server i is then incremented (step 1000) and a determination is made as to whether i<M (step 1010). If it is, the operation returns to step 990. Otherwise, convergence of the k_{i,j}^{(k)} values is checked by comparing them with the k_{i,j}^{(k)} (old) values (step 1020). If there is no convergence, the each old arrival rate valve k_{i,j}^{(k)} (old) is reset to be k_{i,j}^{(k)}, and each old GPS parameter f_{i,k} (old) is reset to be f_{i,k} (step 1030). The operation then returns to step 940.

If there is convergence in step 1020, convergence of the f_{i,k} values is checked by comparing them with the f_{i,k} (old) values (step 1040). If there is no convergence the operation goes to step 1030, described above. Otherwise the optimal arrival rates k_{i,j}^{(k)} and the optimal GPS parameters f_{i,k} for each server i, site j and class K have been identified and the operation terminates.

Thus, the present invention provides a mechanism by which the optimum resource allocation may be determined in order to maximize the profit generated by the computing system. The present invention provides a mechanism for finding the optimal solution by modeling the computing system based on the premise that revenue is generated when service level agreements are met and a penalty is paid when service level agreements are not met. Thus, the present invention performs optimum resource allocation using a revenue metric rather than performance metrics.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiments were chosen and described in order to best explain the principles of the invention, the practical application, and to enable others of ordinary skill in the art to understand the invention for various embodiments with various modifications as are suited to the particular use contemplated.

What is claimed is:

1. A method of allocating resources of a computing system to hosting of a data network site to thereby maximize generated profit, comprising:
calculating a total profit for processing requests received by the computing system for the data network site based on at least one service level agreement; and
allocating resources of the computing system to maximize the total profit.

2. The method of claim 1, wherein calculating a total profit includes, for each request received by the computing system for the data network site, determining whether processing of the request generates a profit or a penalty, wherein a profit is generated when the allocation of resources is such that the request is processed in accordance with the service level agreement and a penalty is generated when the allocation of resources is such that the request is not processed in accordance with the service level agreement.

3. The method of claim 1, wherein calculating a total profit includes using a cost model in which profit is gained for each request to the data network site that is processed in accordance with a service level agreement and a penalty is paid for each request to the data network site that is not processed in accordance with the service level agreement.

4. The method of claim 1, wherein the requests are classified into one or more classes of requests and each class of request has a corresponding service level agreement from the at least one service level agreement.

5. The method of claim 1, wherein allocating resources includes determining an optimal traffic assignment for routing requests to thereby maximize the total profit.

6. The method of claim 1, wherein the computing system is a web server farm and wherein the resources are servers of the web server farm.

7. The method of claim 6, further comprising determining an optimum resource allocation to maximize the total profit.

8. The method of claim 7, wherein determining an optimum resource allocation includes:
modeling the resource allocation as a queuing network;
decomposing the queuing network into separate queuing systems; and
summing cost calculations for each of the separate queuing systems.

9. The method of claim 8, further comprising optimizing the summed cost calculations to maximize generated profit and thereby determine an optimum resource allocation.

10. The method of claim 1, wherein allocating resources includes determining an optimum traffic assignment and an optimum generalized processor sharing coefficient for a class of requests.

11. The method of claim 1, wherein allocating resources includes optimizing a cost function associated with a class of requests.

12. The method of claim 11, wherein optimizing the cost function includes modeling the optimization as a network flow from a source, through sinks representing sites/classes of request and servers/classes of requests, to a supersink.

13. The method of claim 8, wherein decomposing the queuing network into separate queuing systems includes decomposing the queuing network into decomposed models for each class in a hierarchical manner.

14. The method of claim 13, wherein a decomposed model for class k is based on a decomposed model of classes 1 through k-1.

15. An apparatus for allocating resources of a computing system to hosting of a data network site to thereby maximize generated profit, comprising:
means for calculating a total profit for processing requests received by the computing system for the data network site based on at least one service level agreement; and
means for allocating resources of the computing system to maximize the total profit.

16. The apparatus of claim 15, wherein the means for calculating a total profit includes means for determining whether processing of each request generates a profit or a penalty for each request received by the computing system for the data network site, wherein a profit is generated when the allocation of resources is such that the request is processed in accordance with the service level agreement and a penalty is generated when the allocation of resources is such that the request is not processed in accordance with the service level agreement.

17. The apparatus of claim 15, wherein the means for calculating a total profit includes means for using a cost model in which profit is gained for each request to the data network site that is processed in accordance with a service level agreement and a penalty is paid for each request to the data network site that is not processed in accordance with the service level agreement.

18. The apparatus of claim 15, wherein the requests are classified into one or more classes of requests and each class of request has a corresponding service level agreement from the at least one service level agreement.

19. The apparatus of claim 15, wherein the means for allocating resources includes means for determining an optimal traffic assignment for routing requests to thereby maximize the total profit.

20. The apparatus of claim 15, wherein th e computing system is a web server farm and wherein the resources are servers of the web server farm.

21. The apparatus of claim 20, further comprising means for determining an optimum resource allocation to maximize the total profit.

22. The apparatus of claim 21, wherein the means for determining an optimum resource allocation includes:
means for modeling the resource allocation as a queuing network;
means for decomposing the queuing network into separate queuing systems; and
means for summing cost calculations for each of the separate queuing systems.

23. The apparatus of claim 22, further comprising means for optimizing the summed cost calculations to maximize generated profit and thereby determine an optimum resource allocation.

24. The apparatus of claim 15, wherein the means for allocating resources includes means for determining an optimum traffic assignment and an optimum generalized processor sharing coefficient for a class of requests.

25. The apparatus of claim 15, wherein the means for allocating resources includes means for optimizing a cost function associated with a class of requests.

26. The apparatus of claim 25, wherein the means for optimizing the cost function includes means for modeling the optimization as a network flow from a source, through sinks representing sites/classes of request and servers/classes of requests, to a supersink.

27. The apparatus of claim 22, wherein the means for decomposing the queuing network into separate queuing systems includes means for decomposing the queuing network into decomposed models for each class in a hierarchical manner.

28. The apparatus of claim 27, wherein a decomposed model for class k is based on a decomposed model of classes 1 through k-1.

29. A computer program product in a computer readable medium for allocating resources of a computing system to hosting of a data network site to thereby maximize generated profit, comprising:
first instructions for calculating a total profit for processing requests received by the computing system for the data network site based on at least one service level agreement; and
second instructions for allocating resources of the computing system to maximize the total profit.

30. The computer program product of claim 29, wherein the first instructions include instructions for determining whether processing of each request generates a profit or a penalty for each request received by the computing system for the data network site, wherein a profit is generated when the allocation of resources is such that the request is processed in accordance with the service level agreement and a penalty is generated when the allocation of resources is such that the request is not processed in accordance with the service level agreement.

31. The computer program product of claim 29, wherein the first instructions include instructions for using a cost model in which profit is gained for each request to the data network site that is processed in accordance with a service level agreement and a penalty is paid for each request to the data network site that is not processed in accordance with the service level agreement.

32. The computer program product of claim 29, wherein the requests are classified into one or more classes of requests and each class of request has a corresponding service level agreement from the at least one service level agreement.

33. The computer program product of claim 29, wherein the second instructions include instructions for determining an optimal traffic assignment for routing requests to thereby maximize the total profit.

34. The computer program product of claim 29, wherein the computing system is a web server farm and wherein the resources are servers of the web server farm.

35. The computer program product of claim 34, further comprising third instructions for determining an optimum resource allocation to maximize the total profit.

36. The computer program product of claim 35, wherein the third instructions include:
instructions for modeling the resource allocation as a queuing network;
instructions for decomposing the queuing network into separate queuing systems; and
instructions for summing cost calculations for each of the separate queuing systems.

37. The computer program product of claim 36, further comprising instructions for optimizing the summed cost calculations to maximize generated profit and thereby determine an optimum resource allocation.

38. The computer program product of claim 29, wherein the second instructions include instructions for determining an optimum traffic assignment and an optimum generalized processor sharing coefficient for a class of requests.

39. The computer program product of claim 29, wherein the second instructions include instructions for optimizing a cost function associated with a class of requests.

40. The computer program product of claim 39, wherein the instructions for optimizing the cost function includes instructions for modeling the optimization as a network flow from a source, through sinks representing sites/classes of request and servers/classes of requests, to a supersink.

41. The computer program product of claim 36, wherein the instructions for decomposing the queuing network into separate queuing systems includes instructions for decomposing the queuing network into decomposed models for each class in a hierarchical manner.

42. The computer program product of claim 41, wherein a decomposed model for class k is based on a decomposed model of classes 1 through k-1.
